(19) United States
(12) Patent Application Publication
(10) Pub. No.: US 2024/0334323 A1
(43) Pub. Date: Oct. 3, 2024

(54) ENERGY SAVING IN SERVICE-BASED ACCESS NETWORK

(71) Applicant: Nokia Technologies Oy, Espoo (FI)

(72) Inventors: Ece OZTURK, Munich (DE); Ömer BULAKCI, Munich (DE)

(21) Appl. No.: 18/575,030

(22) PCT Filed: Jun. 29, 2021
(86) PCT No.: PCT/EP2021/067782

§ 371 Date: Dec. 28, 2023

(51) Int. Cl. H04W 52/02

(52) U.S. Cl. CPC H04W 52/0206

(57) ABSTRACT

There are provided measures for enabling/realizing energy saving in a service-based access network such as a service-based radio access network, particularly energy saving at a specified granularity in a service-based access network such as a service-based radio access network. Such measures exemplarily comprise that a node or element in the service-based access network captures an energy saving request or command of an energy saving service in the service-based access network, wherein the energy saving request or command enables that the specified granularity can be deduced, and is configured to request or command initiation of an energy saving mode, notifies one or more service consumer entities of initiation of the requested or commanded energy saving mode, and initiates the requested or commanded energy saving mode.

### FIELD

The present disclosure relates to energy saving in a service-based access network such as a service-based radio access network. More specifically, the present disclosure relates to measures/mechanisms (including methods, apparatuses (i.e. devices, entities, elements and/or functions) and computer program products) for enabling/realizing energy saving in a service-based access network such as a service-based radio access network.

### BACKGROUND

Basically, the present disclosure relates to energy saving in a (radio) access network of a mobile/wireless communication system, e.g. a 3GPP-standardized mobile/wireless communication system, such as a 5G/NR system or next generations beyond 5G (i.e., 6G, 7G, . . . ).

In modern mobile/wireless communication systems, such as 5G/NR systems, energy saving is performed to optimize the energy consumption, e.g. via cell activation/deactivation signaled via Cell Activation procedures over the Xn interface between two gNBs and gNB DU/CU Configuration Update procedures over the F1 interface between a central unit (CU) and a distributed unit (DU) in case of a disaggregated gNB.

More specifically, the present disclosure relates to energy saving in a service-based (radio) access network, i.e. a (radio) access network of a service-based (SB) architecture (SBA).

Recently, mobile/wireless communication systems are increasingly deployed in cloud environments. Furthermore, modern and future mobile/wireless communication systems are aimed to be flexible by adding new functionalities into the system capitalizing on cloud implementations. To this end, a service-based (SB) architecture (SBA) is implemented, in which network functions are represented in a service-based manner, such network functions enable other authorized network functions to access their services, and service-based interfaces are defined, through which such service accesses among such network functions are enabled.

FIG. 1 shows a schematic block diagram illustrating a conventional 5G system configuration based on SBA principles. As shown in FIG. 1, the 5G core network (5GC) is defined as a service-based (SB) architecture (SBA), as illustrated in the upper part of FIG. 1, and the network management is also employing SBA principles, referred to as service-based management architecture (SBMA), as illustrated in the lower part of FIG. 1.

In the 5GC SBA, a consumer inquires a network repository function (NRF) in order to discover an appropriate service producer entity. That is, in 5GC, in order to discover and select the appropriate service entities, multiple filtering criteria may be applied by the NRF.

5GC SBA Application Programming Interfaces (APIs) are based on the HTTP(S) protocol. A Network Function (NF) service is one type of capability exposed by an NF (NF service producer entity) to another authorized NF (NF service consumer entity) through a service-based interface (SBI). A Network Function (NF) may expose one or more NF services. NF services may communicate directly between NF service consumer entities and NF service producer entities, or indirectly via a Service Communication Proxy (SCP).

However, the access network such as the radio access network, as illustrated by (R)AN in the upper part of FIG. 1, and the associated interfaces, e.g. interfaces within (R)AN, among (R)ANs, and between (R)AN and the core network are still implemented/defined in a legacy manner, e.g. as legacy point-to-point (P2P) interfaces. For example, in the 5G System (5GS), N2 is designed as a 3GPP NG-C Application Protocol over SCTP between gNB (or ng-eNB) and AMF (Access and Mobility management Function). Further examples of P2P interfaces within (R)AN or among (R)ANS, i.e., RAN entities, include the Xn interface between two gNBs, the F1 interface between a central unit (CU) and a distributed unit (DU) in case of a disaggregated gNB, and the E1 interface between the CU-CP and the CU-UP in case of a disaggregated CU.

An access network (AN) can be defined as a network that offers access (such as radio access) that enables to connect subscribers to one or more core networks. The access network may provide 3GPP access such as GSM/EDGE, UTRA, E-UTRA, or NR access or non-3GPP access such as WLAN/Wi-Fi. The access network is contrasted with the core network, which is an architectural term relating to the part of the network (e.g. 3GPP network) which is independent of the connection technology of the terminal (e.g. radio, wired) and which provides core network services such as subscriber authentication, user registration, connectivity to packet data networks, subscription management, etc. An access network and a core network may correspond respectively e.g. to a 3GPP access network and 3GPP core network.

Herein, an entity can be, e.g., a logical entity, an access node, a base station, a part of an access node or base station, a protocol stack, a part of a protocol stack, a network function, a part of a network function, or the like.

The application of SBA principles to the (R)AN and the associated interfaces would imply substantial updates, such as the adaptation of existing mechanisms and functions to such concept as well as the definition of new functions and services that are beneficial or crucial for operating under this concept. Thus, various aspects are to be considered for realization of a service-based (R)AN (SB-(R)AN) environment in mobile/wireless communication systems, i.e. an overall SB system configuration or framework.

As indicated above, in modern mobile/wireless communication systems, energy saving is performed on P2P interfaces. Hence, current concepts and operations for energy saving do not comply with and, thus, do not work in a service-based (R)AN environment.

Accordingly, there is currently no technique for energy saving in a service-based (radio) access network, i.e. a service-based (R)AN environment.

Therefore, there is a desire/need for a technique for (enabling/realizing) energy saving in a service-based (radio) access network, i.e. a service-based (R)AN environment.

### SUMMARY

Various exemplifying embodiments of the present disclosure aim at addressing at least part of the above issues and/or problems and drawbacks.

Various aspects of exemplifying embodiments of the present disclosure are set out in the appended claims.

According to an example aspect of the present disclosure, there is provided a method of (or, stated in other words, operable or for use in/by) a node or element in a service-based access network, comprising capturing an energy saving request or command which is configured to trigger an energy saving service in the service-based access network, and requesting or commanding initiation of an energy saving mode of one or more service producer entities in the service-based access network according to the energy saving request or command.

According to an example aspect of the present disclosure, there is provided an apparatus of (or, stated in other words, operable or for use in/by) a node or element in a service-based access network, the apparatus comprising at least one processor and at least one memory including computer program code, wherein the processor, with the at least one memory and the computer program code, is configured to cause the apparatus to perform: capturing an energy saving request or command which is configured to trigger an energy saving service in the service-based access network, and requesting or commanding initiation of an energy saving mode of one or more service producer entities in the service-based access network according to the energy saving request or command.

According to an example aspect of the present disclosure, there is provided an apparatus of (or, stated in other words, operable or for use in/by) a node or element in a service-based access network, comprising: means or circuitry for capturing an energy saving request or command which is configured to trigger an energy saving service in the service-based access network, and means or circuitry requesting or commanding initiation of an energy saving mode of one or more service producer entities in the service-based access network according to the energy saving request or command

According to various developments/modifications of the above aspects, any one of the aforementioned method-related and/or apparatus-related example aspects of the present disclosure may include one or more of the following features:
the one or more service producer entities comprise at least one of: one or more network functions, which are configured to produce a service in or for the service-based access network, one or more microservices, which are configured to produce a service in or for the service-based access network, one or more communication control entity units, which are configured to produce a service for one or more cells, such as one or more distributed units of a base station entity, and one or more cells, which are configured to produce a service for one or more user equipment entities, such as a base transceiver or radio entity, and/or one or more sectors of at least one cell and/or one or more beams of at least one cell,
the method, functionality or operability further comprises identifying and/or retrieving information of the one or more service producer entities, and/or notifying one or more of the service producer entities of specifics of the requested or commanded energy saving mode,
the specifics comprise at least one of: an inactivity period specifying a time period of inactivity in the energy saving mode of a respective service producer entity, and a service producer alternative specifying one or more alternative service producer entities which are configured to produce a similar or equivalent service as a respective service producer entity,
at least one of the requesting or commanding and the notifying is performed by issuing an energy saving request or command to the one or more service producer entities,
the method, functionality or operability further comprises synchronizing UE contexts of associated user equipment entities, which are concerned by the requested or commanded energy saving mode, in or for the one or more service producer entities, and/or updating registers of the one or more service producer entities, and/or removing or clearing existing subscriptions, which are concerned by the requested or commanded energy saving mode, and/or closing affected connections, which are concerned by the requested or commanded energy saving mode,
the UE contexts are synchronized by issuing a UE context synchronization indication request, and/or the registers are updated and/or the existing subscriptions are removed or cleared and/or the affected connections are closed at a corresponding network function,
capturing the energy saving request or command comprises: receiving the energy saving request or command in a central way, such as from a central entity, or in a distributed way, such as based on policies or from any service producer entity or network function,
the node or element is or relates to a communication control entity unit, which is configured to produce a control- or management-related service, such as a central unit or a central unit control plane of a base station entity,
the service-based access network is based on a 3GPP standard or part of a 3GPP-based communication system, such as a system of or beyond 5G.

According to an example aspect of the present disclosure, there is provided a method of (or, stated in other words, operable or for use in/by) a node or element in a service-based access network, comprising capturing an energy saving request or command of an energy saving service in the service-based access network, which is configured to request or command initiation of an energy saving mode, notifying one or more service consumer entities of initiation of the requested or commanded energy saving mode, and initiating the requested or commanded energy saving mode.

According to an example aspect of the present disclosure, there is provided an apparatus of (or, stated in other words, operable or for use in/by) a node or element in a service-based access network, the apparatus comprising at least one processor and at least one memory including computer program code, wherein the processor, with the at least one memory and the computer program code, is configured to cause the apparatus to perform: capturing an energy saving request or command of an energy saving service in the service-based access network, which is configured to request or command initiation of an energy saving mode, notifying one or more service consumer entities of initiation of the requested or commanded energy saving mode, and initiating the requested or commanded energy saving mode.

According to an example aspect of the present disclosure, there is provided an apparatus of (or, stated in other words, operable or for use in/by) a node or element in a service-based access network, comprising: means or circuitry for capturing an energy saving request or command of an energy saving service in the service-based access network, which is configured to request or command initiation of an energy saving mode, means or circuitry for notifying one or more service consumer entities of initiation of the requested or commanded energy saving mode, and means or circuitry for initiating the requested or commanded energy saving mode.

According to various developments/modifications of the above aspects, any one of the aforementioned method-related and/or apparatus-related example aspects of the present disclosure may include one or more of the following features:
the service consumer entities comprise entities which are consuming a service of or via the node or element and/or entities which were consuming a service of or via the node or element,
the service consumer entities comprise at least one of: one or more network functions, one or more microservices, one or more communication control entity units, such as one or more distributed units of a base station entity, and one or more cells and/or one or more sectors of at least one cell and/or one or more beams of at least one cell,
the notifying comprises identifying and/or retrieving information of the one or more service consumer entities, and/or notifying the one or more service consumer entities of specifics of the requested or commanded energy saving mode,
the specifics comprise at least one of: an inactivity period specifying a time period of inactivity in the energy saving mode of the node or element, and a service producer alternative specifying one or more alternative service producer entities which are configured to produce a similar or equivalent service as the node or element,
the inactivity period is notified to service consumer entities which are consuming a service of or via the node or element and/or service consumer entities which were consuming a service of or via the node or element and/or the service producer alternative is notified to service consumer entities which are consuming a service of or via the node or element,
the notifying is performed by issuing an energy saving indication to the one or more service consumer entities,
the method, functionality or operability further comprises updating registers of the one or more service consumer entities, and/or removing or clearing existing subscriptions, which are concerned by the requested or commanded energy saving mode, and/or closing affected connections, which are concerned by the requested or commanded energy saving mode, and/or converting affected connections, which are concerned by the requested or commanded energy saving mode, to be inactive or idle, and/or establishing a new connection to at least one alternative service producer entity configured to produce a similar or equivalent service as the node or element,
the registers are updated and/or the existing subscriptions are removed or cleared and/or the affected connections are closed at a corresponding network function,
capturing the energy saving request or command comprises: receiving the energy saving request or command from a node or element in the service-based access network, which is or relates to a communication control entity unit, which is configured to produce a control- or management-related service, such as a central unit or a central unit control plane of a base station entity,
the node or element represents a service producer entity which is configured to produce a service in the service-based access network, the node or element is or relates to one or more of a network function, a microservice, a communication control entity unit, such as a distributed unit of a base station entity, and a cell,
the service-based access network is based on a 3GPP standard or part of a 3GPP-based communication system, such as a system of or beyond 5G.

According to an example aspect of the present disclosure, there is provided a method of (or, stated in other words, operable or for use in/by) a node or element in a service-based access network, comprising capturing an energy saving indication which is configured to notify of initiation of an energy saving mode which is requested or commanded to be initiated by one or more service producer entities in an energy saving service in the service-based access network, and controlling operation according to the energy saving indication.

According to an example aspect of the present disclosure, there is provided an apparatus of (or, stated in other words, operable or for use in/by) a node or element in a service-based access network, the apparatus comprising at least one processor and at least one memory including computer program code, wherein the processor, with the at least one memory and the computer program code, is configured to cause the apparatus to perform: capturing an energy saving indication which is configured to notify of initiation of an energy saving mode which is requested or commanded to be initiated by one or more service producer entities in an energy saving service in the service-based access network, and controlling operation according to the energy saving indication,

According to an example aspect of the present disclosure, there is provided an apparatus of (or, stated in other words, operable or for use in/by) a node or element in a service-based access network, comprising: means or circuitry for capturing an energy saving indication which is configured to notify of initiation of an energy saving mode which is requested or commanded to be initiated by one or more service producer entities in an energy saving service in the service-based access network, and means or circuitry for controlling operation according to the energy saving indication.

According to various developments/modifications of the above aspects, any one of the aforementioned method-related and/or apparatus-related example aspects of the present disclosure may include one or more of the following features:
the energy saving indication is further configured to notify of specifics of the energy saving mode which is requested or commanded to be initiated by the one or more service producer entities,
the specifics comprise at least one of: an inactivity period specifying a time period of inactivity in the energy saving mode of the one or more service producer entities, and a service producer alternative specifying one or more alternative service producer entities which are configured to produce a similar or equivalent service as the one or more service producer entities,
the controlling comprises: updating at least one register of the node or element, and/or removing or clearing existing subscriptions, which are concerned by the requested or commanded energy saving mode, and/or closing affected connections, which are concerned by the requested or commanded energy saving mode, and/or converting affected connections, which are concerned by the requested or commanded energy saving mode, to be inactive or idle, and/or establishing a new connection to at least one alternative service producer entity configured to produce a similar or equivalent service as the one or more service producer entities,
the at least one register is updated and/or the existing subscriptions are removed or cleared and/or the affected connections are closed at a corresponding network function,
capturing the energy saving indication comprises: receiving the energy saving indication from a node or element in the service-based access network, which represents a service producer entity which is configured to produce a service in the service-based access network,
the node or element represents a service consumer entity which is configured to consume a service produced by one or more of the service producer entities,
the node or element is or relates to one or more of a network function, a microservice, a communication control entity unit, such as a distributed unit of a base station entity and a cell,
the service-based access network is based on a 3GPP standard or part of a 3GPP-based communication system, such as a system of or beyond 5G.

According to an example aspect of the present disclosure, there is provided a computer program product comprising (computer-executable) computer program code which, when the program code is executed (or run) on a computer or the program is run on a computer (e.g. a computer of an apparatus according to any one of the aforementioned apparatus-related example aspects of the present disclosure), is configured to cause the computer to carry out the method according to any one of the aforementioned method-related example aspects of the present disclosure.

The computer program product may comprise or may be embodied as a (tangible/non-transitory) computer-readable (storage) medium or the like, on which the computer-executable computer program code is stored, and/or the program is directly loadable into an internal memory of the computer or a processor thereof.

Further developments and/or modifications of the aforementioned exemplary aspects of the present disclosure are set out in the following.

By way of exemplifying embodiments of the present disclosure, energy saving in a service-based (radio) access network, i.e. a service-based (R)AN environment, can be enabled/realized. Moreover, energy saving in the service-based (radio) access network can be enabled/realized at a specified granularity, e.g. a higher granularity as feasible for energy saving in such mobile/wireless communication systems.

### BRIEF DESCRIPTION OF THE DRAWINGS

In the following, the present disclosure will be described in greater detail by way of non-limiting examples with reference to the accompanying drawings, in which

FIG. 1 shows a schematic block diagram illustrating a conventional 5G system configuration based on SBA principles.

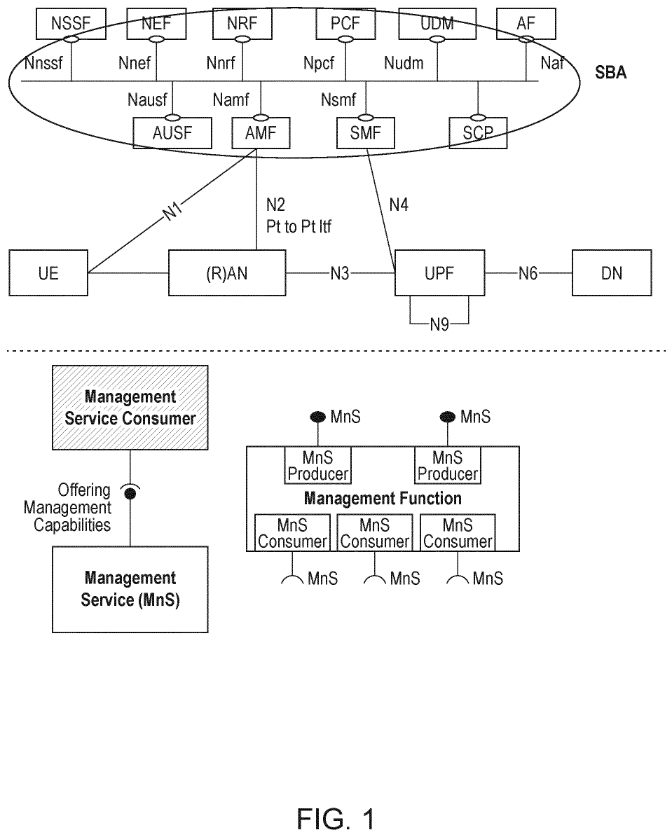

FIG. 2 shows a schematic block diagram illustrating an example of an overall service-based system configuration according to at least one exemplifying embodiment,

FIG. 3 shows a schematic block diagram illustrating an example of an energy saving operation (or energy saving service operation) in a service-based (radio) access network according to at least one exemplifying embodiment,

FIG. 4 shows a sequence diagram illustrating an example of an energy saving procedure (or energy saving service procedure) according to at least one exemplifying embodiment,

FIG. 5 shows a flowchart illustrating an example of a method or process according to at least one exemplifying embodiment,

FIG. 6 shows a flowchart illustrating an example of a method or process according to at least one exemplifying embodiment,

FIG. 7 shows a flowchart illustrating an example of a method or process according to at least one exemplifying embodiment,

FIG. 8 shows a schematic block diagram illustrating an example of a structure of apparatuses according to at least one exemplifying embodiment, and

FIG. 9 shows a schematic block diagram illustrating an example of a structure of apparatuses according to at least one exemplifying embodiment.

### DETAILED DESCRIPTION

The present disclosure is described herein with reference to particular non-limiting examples and to what are presently considered to be conceivable (examples of) embodiments. A person skilled in the art will appreciate that the present disclosure is by no means limited to these examples and embodiments, and may be more broadly applied.

It is to be noted that the following description mainly refers to specifications being used as non-limiting examples for certain exemplifying network configurations and system deployments. Namely, the following description mainly refers to 3GPP standards, specially referring to 5G/NR and beyond 5G (i.e. 6G, 7G, . . . ) standardizations, being used as non-limiting examples. As such, the description of exemplifying embodiments given herein specifically refers to terminology which is directly related thereto. Such terminology is only used in the context of the presented non-limiting examples and embodiments, and does naturally not limit the present disclosure in any way. Rather, any other system configuration or deployment may equally be utilized as long as complying with what is described herein and/or exemplifying embodiments described herein are applicable to it.

For examples, the present disclosure is equally applicable in modern communication systems, such as 5G/NR systems, and future communication systems, such as next generations beyond 5G (i.e. 6G, 7G, . . . ).

Hereinafter, various exemplifying embodiments and implementations of the present disclosure and its aspects are described using several variants and/or alternatives. It is generally to be noted that, according to certain needs and constraints, all of the described variants and/or alternatives may be provided alone or in any conceivable combination (also including combinations of individual features of the various variants and/or alternatives). In this description, the words “comprising” and “including” should be understood as not limiting the described exemplifying embodiments and implementations to consist of only those features that have been mentioned, and such exemplifying embodiments and implementations may also contain features, structures, units, modules etc. that have not been specifically mentioned.

In the drawings, it is to be noted that lines/arrows interconnecting individual blocks or entities are generally meant to illustrate an operational coupling there-between, which may be a physical and/or logical coupling, which on the one hand is implementation-independent (e.g. wired or wireless) and on the other hand may also comprise an arbitrary number of intermediary functional blocks or entities not shown. In flowcharts or sequence diagrams, the illustrated order of operations or actions is generally illustrative/exemplifying, and any other order of respective operations or actions is equally conceivable, if feasible.

According to exemplifying embodiments of the present disclosure, in general terms, there are provided measures/mechanisms (including methods, apparatuses (i.e. devices, entities, elements and/or functions) and computer program products) for enabling/realizing energy saving in a service-based (radio) access network, i.e. a service-based (R)AN environment, particularly energy saving in the service-based (radio) access network at a specified granularity (e.g., a higher granularity as compared to energy saving in a non-service-based (radio) access network).

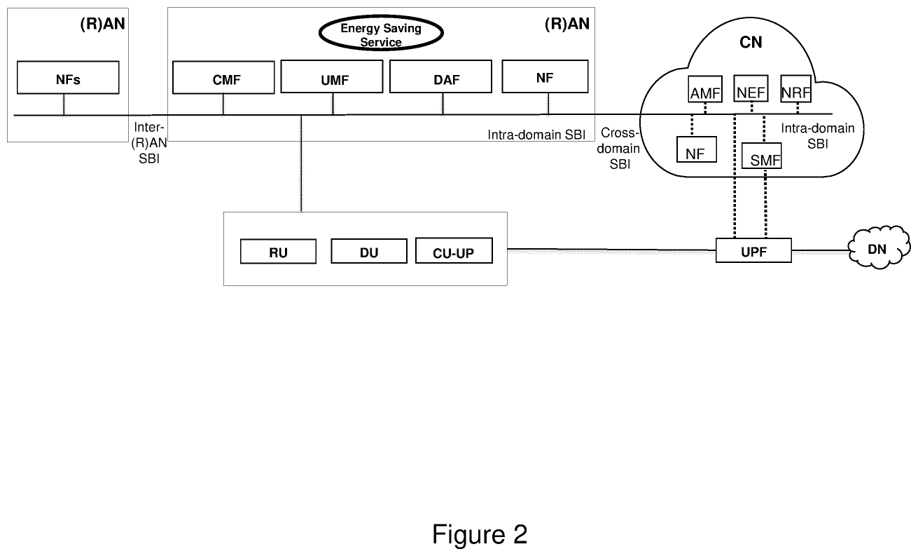

FIG. 2 shows a schematic block diagram illustrating an example of an overall service-based (SB) system configuration (or architecture/framework) according to at least one exemplifying embodiment. Such SB system configuration is exemplarily based on a 5G system configuration.

As shown in FIG. 2, a (R)AN representing an exemplary CU-CP domain comprises one or more network functions, wherein CMF, UMF and DAF are non-limiting examples of network functions and NF generally denotes any network function, and a CN representing a domain comprises network functions such as those of a conventional SB-5GC, wherein AMF, NEF, NRF and SMF denote respective examples of network functions and NF generally denotes any network function. In the thus illustrated SB system configuration, each domain comprises an intra-domain SBI, and different domains are interconnected by respective cross-domain or inter-(R)AN SBIs. Here, although the SBIs are distinguished with respect to network domains, a unified SBI across different network domains can also be implemented. In such an architecture with a unified SBI, any authorized NFs may communicate with each other, e.g. across different network domains. For the sake of intelligibility, a non-CU-CP domain, which exemplarily comprises a RU, a DU and a CU-UP, a UPF and a DN are also illustrated without detailing service-based architecture therein.

As indicated in FIG. 2, an energy saving service may be realized/implemented in a service-based (R)AN according to at least one exemplifying embodiment. The energy saving service may be introduced as part of an existing network function or a new network function or a combination thereof, or may be introduced as an existing microservice, a new microservice or a combination thereof, or may be introduced as a combination of existing and/or new network functions and microservices. Details of the energy saving service (or, more generally, energy saving) and related operations, procedures, methods and processes are described later.

It is to be noted that, in the present disclosure, service-based configuration, architecture or framework encompasses a microservice configuration, architecture or framework. That is, a service-based (R)AN according to at least one exemplifying embodiment may be based on or comprise a microservice approach such that one or more network functions or one or more services within one or more network functions or one or more functionalities/mechanisms/processes of services of one or more network functions represent or comprise a set/collection of interacting microservices. Accordingly, in a service-based (R)AN according to at least one exemplifying embodiment, a service may be produced or provided by any one of a network function, a microservice, a communication control entity and a cell.

Microservices could be understood as more modular services (as compared with services produced/provided by NFs) that come together to provide a meaningful service/application. In this scope, one can deploy and scale the small modules flexibly (e.g. within a NF or between various NFs). For example, a NF provides a service, and a microservice can represent small modules that make up the service. When a service is clogged at a specific module, then one can scale the individual module/s in microservice scope instead of the whole service as it would happen in network function scope. In microservice scope, energy saving according to at least one exemplifying embodiment would work the other way around, namely there is no need for a specific module to operate the service anymore, so the individual microservice would be shut down or deactivated.

According to at least one exemplifying embodiment, energy saving may be performed or defined as a service, namely an energy saving service, in a service-based (R)AN. The energy saving and, thus, the energy saving service may be triggered for energy saving optimizations, e.g. via a request or command by a) in a central way or by a central entity such as e.g. O-RAN RIC, SMO, OAM, etc. entity or b) in a distributed way such as e.g. based on policies or any authorized (R)AN NF. Such energy saving optimizations are achieved in that at least some entity in the service-based (R)AN, e.g. a network function, a microservice, a communication control entity, a cell, or the like, initiates an energy saving mode, i.e. becomes inactive, shut down, deactivated, or the like, according to the energy saving request or command.

According to at least one exemplifying embodiment, energy saving (in/by the energy saving service) may be performed at a specified granularity, namely at one or more of different (structural, logical or administrative) levels in a service-based (R)AN. For example, energy saving may be performed at one or more of a DU level (i.e. for/in one or more DUs), a cell level (i.e. for/in one or more cells), a sector level (i.e. for/in one or more sectors in/of a cell), a beam level (i.e. for/in one or more beams in/of a cell), a NF level (i.e. for/in one or more NFs), a microservice level (i.e. for/in one or more microservices), or the like. Hence, energy saving may not only be performed at a cell level (like in current (non-SB) systems or (radio) access networks), but with higher/increased granularity. Such granularity may be indicated (by information) in an energy saving request or may be or may be deduced from (identification information, etc.) in an energy saving request.

Thereby, energy saving according to at least one exemplifying embodiment can be effectuated or performed for/at any service producer entity in a service-based (R)AN, depending or based on the energy saving request/command or the thus specified (requested/commanded) granularity. As explained below, such service producer entities may exemplarily comprise one or more of the following: one or more network functions, which are configured to produce a service in or for the service-based (R)AN, e.g. a network-related service or a UE-related service, one or more microservices, which are configured to produce a service in or for the service-based (R)AN, e.g. a network-related service or a UE-related service, one or more communication control entity units (such as a DU e.g. of a gNB or ng-eNB or en-gNB), which are configured to produce a service for one or more cells, e.g. a control- or management-related service, and/or one or more cells (such as a base transceiver or radio entity), which are configured to produce a service for one or more UE entities, e.g. a communication-related service.

According to at least one exemplifying embodiment, energy saving (in/by the energy saving service) may be performed temporarily, i.e. for a specific inactivity period. Such temporary energy saving may be performed at a specific granularity. For example, referring to the aforementioned granularity example, energy saving (by way of inactivity) may be performed for/with some inactivity period at a DU level, or may be performed for/with a first inactivity period at a DU level and for/with a second inactivity period at a NF and/or microservice level. This can be used to optionally keep existing connections, avoiding the connection re-establishing latencies, keep existing subscriptions, or the like.

According to at least one exemplifying embodiment, energy saving (in/by the energy saving service) may be performed for/in a first group of (one or more) service producer entities. If so, the (one or more) service producer entities of the first group, which are requested or commanded to initiate an energy saving mode, may proactively inform (one or more) service consumer entities (i.e. entities consuming a service of or via at least one of the service producer entities), i.e. provide a notification of the (upcoming) initiation of the requested or commanded energy saving mode. This can be used for optimizing (control of) operations at/by the thus informed service consumer entities. For service consumer entities which are (currently) consuming a service of or via at least one of the service producer entities, which may be regarded as belonging to a second group, such proactive information or notification can help ensuring minimized or no interruption in the operation of such (second-group) service consumer entities. For service consumer entities which were (previously) consuming a service of or via at least one of the service producer entities, which may be regarded as belonging to a third group, such proactive information or notification can help ensuring a graceful update of valid/invalid connections of such (third-group) service consumer entities.

According to at least one exemplifying embodiment, in energy saving (in/by the energy saving service), the aforementioned proactive information or notification may include specifics of the requested or commanded energy saving mode. For example, such specifics may comprise an inactivity period specifying a time period of inactivity in the energy saving mode of a (first-group) service producer entity, a service producer alternative specifying one or more alternative service producer entities which are configured to produce a similar or equivalent service as a respective (first-group) service producer entity, or the like. For example, a corresponding indication from a (first-group) service producer entity to a (second-group) service consumer entity and/or a (third-group) service consumer entity may include an inactivity time period, during and after which the (first-group) service producer entity is in an inactive state and resumed active state, respectively. Thereby, any (second-group) service consumer entity can optionally keep the connection alive for the duration of the inactivity for reduced connection reestablishment latencies, and/or any (third-group) service consumer entity can have information on and/or gracefully update the valid/invalid connections. Further, for example, a corresponding indication from a (first-group) service producer entity to a (second-group) service consumer entity may include alternative service producer entities (e.g. NFs) providing similar services produced by the (first-group) service producer entity (e.g. NF) so that the (second-group) service consumer entity can optionally subscribe to (one of) the announced alternative service producer entities for service continuation.

According to at least one exemplifying embodiment, in energy saving (in/by the energy saving service), associated UEs' contexts in (first-group) service producer entities may be synchronized. Such synchronization may exemplarily be effectuated or performed at a corresponding entity (e.g. NF). For example, depending on an implementation or use case, this can be accomplished by/via a UE Context Sync Indication request from Cell Management Function (CMF) to UE Management Function (UMF), potentially followed by initiation UE of a Context synchronization service/method/operation defined and implemented in the UMF.

In the following, some illustrative examples of operations and procedures of energy saving in a SB-(R)AN according to at least one exemplifying embodiment are given for explaining the aforementioned points or principles.

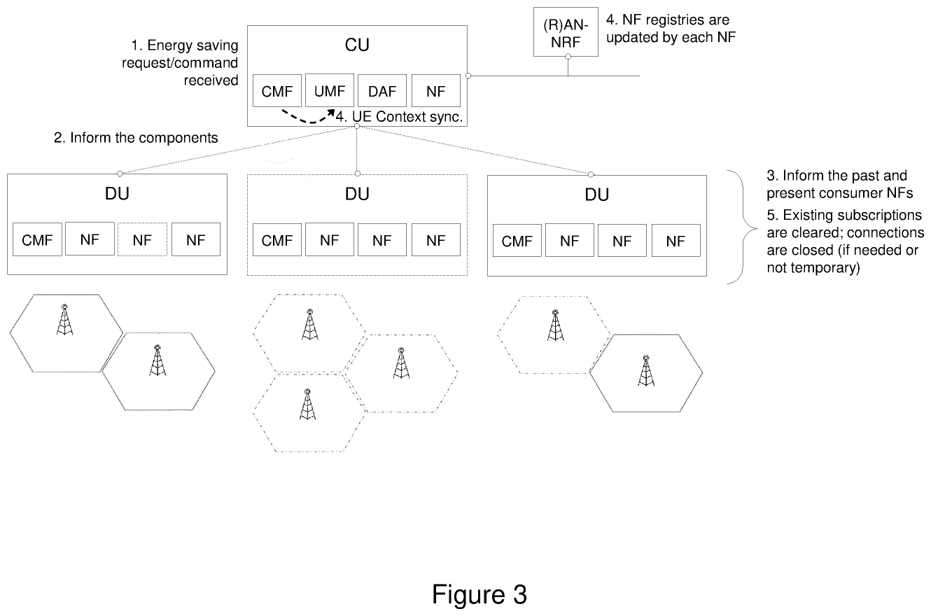

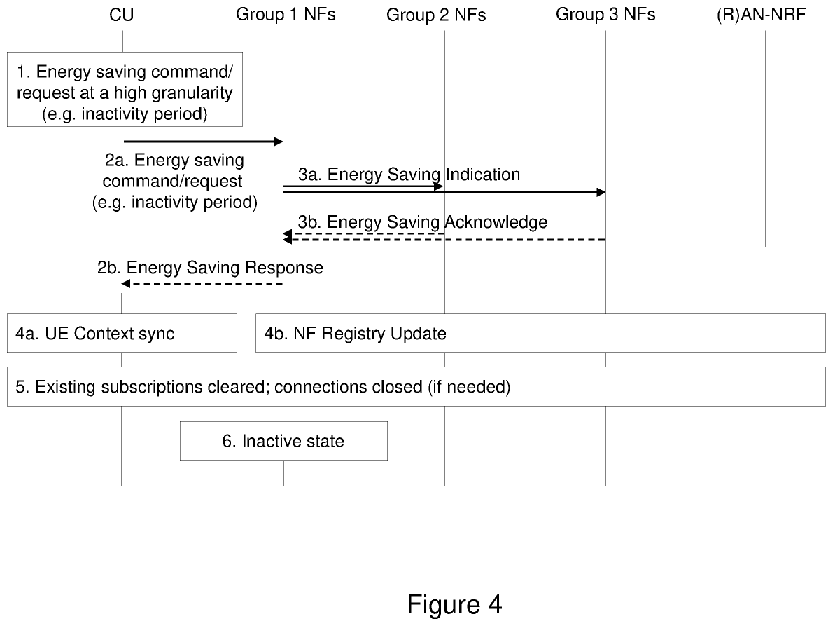

For the sake of simplicity and lucidity, the service producer entity or entities, which are requested or commanded to initiate an energy saving mode, such as (one or more) DUs and/or (one or more) cells and/or (one or more) NFs and/or (one or more) microservices to be made inactivate, shut down or deactivated, are referred to as Group 1 NFs. Further, the service consumer entity or entities, which are (currently) consuming a service of or via any service producer entity or entities of the Group 1 NFs, such as such as (one or more) DUs and/or (one or more) cells and/or (one or more) NFs and/or (one or more) microservices, are referred to as Group 2 NFs, and the service consumer entity or entities, which were (previously) consuming a service of or via any service producer entity or entities of the Group 1 NFs, such as such as (one or more) DUs and/or (one or more) cells and/or (one or more) NFs and/or (one or more) microservices, are referred to as Group 3 NFs. Even more generally, when reference is made NFs in the following description (especially, the description in connection with FIGS. 3 and 4), this shall be understood as referring to any potential entity or component, such as (one or more) DUs and/or (one or more) cells and/or (one or more) NFs and/or (one or more) microservices.

FIG. 3 shows a schematic block diagram illustrating an example of an energy saving operation (or energy saving service operation) in a service-based (radio) access network according to at least one exemplifying embodiment. Namely, the thus illustrated energy saving operation may be realized by/in an energy saving service according to at least one exemplifying embodiment.

The thus exemplified energy saving operation is exemplarily explained in view of an illustrative architecture of a SB-(R)AN, which is based on a CU-DU split as known from 5G specifications. More specifically, the thus exemplified energy saving operation is explained for/in an implementation of a SB-(R)AN, in which a base station entity, unit or component, such as a gNB or ng-eNB or en-gNB, comprises a CU and three DUs, and serves/operates seven cells, as illustrated in FIG. 3. Namely, it is supposed that the energy saving operation is realized at/by a correspondingly configured base station entity, unit or component in the SB-(R)AN.

Therein, as a non-limiting example, the CU (having various network functions such as e.g. CMF, UMF, DAF and any other NFs) controls three DUs (having various network functions such as e.g. CMF and any other NFs), and the DUs control or support a number of cells being depicted directly below them, respectively.

Upon receiving an energy saving request/command at the CU (step 1), the Group 1 NFs are informed accordingly (step 2), either via broadcast or one-to-one communication. Namely, the Group 1 NFs are requested or commanded to initiate an energy saving mode at the specified granularity according to the energy saving request/command. To this end, the energy saving request/command has to be such that the Group 1 NFs can be deduced from it, i.e. has to have a corresponding content. In the present example, energy saving is requested/commanded for/in a NF in the left DU, the middle DU (and thus all of its controlled/supported cells) and the left cell being served/controlled by the right DU, as is indicated by dot-and-dash-line boxes in FIG. 3. Namely, the energy saving request/command may comprise corresponding identifiers of the Group 1 NFs, namely (in the present example) the respective NF, DU and cell identifiers. Hence, these entities or components are (directly) affected by the energy saving request/command, thus representing the Group 1 NFs.

The Group 1 NFs proactively inform the Group 2/3 NFs (step 3), either via broadcast or one-to-one communication. It is to be noted that the communication among the NFs can also be via a proxy or more than one proxy, e.g. similar to the SCP in 5GC. Such proxy can be a NF in the same network domain or a different network domain, e.g. a NF in the core network. Namely, all entities or components which are or were using a service of or via at least one of the Group 1 NFs are identified/detected and informed or, stated in other words, notified of initiation of the requested/commanded energy saving mode (prior to initiation of the requested/commanded energy saving state for/in the Group 1 NFs). Therefore, the Group 2/3 NFs are enabled to control their operations accordingly, thus avoiding or minimizing service interruption during energy saving procedures in the SB-(R)AN. This represents an effect/benefit of energy saving (in/by the energy saving service) according to at least one exemplifying embodiment.

Further, data of the Group 3 NFs can be stored in, updated at and/or retrieved from a node or entity that has storage capabilities of Group 3 NFs and/or Group 2 NFs information, such as a network repository function (NRF) and/or a data storage function of the SB-(R)RAN ((R)AN-DSF) (step 4) so as to be identifiable/detectable by the Group 1 NFs. As noted, the thus stored Group 3 NFs information can be subject to one or more mechanisms/methods that determine their storage state, such as a timer expiry. The associated UEs' contexts in Group 1 NFs can be synchronized at the corresponding NF. For example, this can be accomplished via a UE Context Sync Indication request from Cell Management Function (CMF) to UE Management Function (UMF) in the CU. Affected or all affected NF registries can be updated, e.g. in a repository function of the SB-(R)RAN such as (R)AN Network Repository Function (NRF) or AN-NRF (step 4). Existing or all existing (and affected) subscriptions can be cleared or removed, e.g. in a repository function of the SB-(R)RAN such as (R)AN Network Repository Function (NRF) or AN-NRF, and/or, if needed or appropriate (e.g. depending on an inactivity period according to the requested/commanded energy saving mode), existing or pending connections can be closed (step 5). Any subscriptions which are removed or cleared at this time can be reestablished after re-activation in case of temporary deactivation.

Further, the information or notification (e.g. the indication of deactivation or energy saving) from the Group 1 NFs to (at least one or some of) the Group 2 NFs can include alternative NFs (alternative authorized NFs) providing similar services as produced by the Group 1 NFs (which are to be deactivated or put in an energy saving mode) so that (the thus informed or notified at least one or some of) the Group 2 NFs can optionally subscribe to the announced (authorized) NFs for service continuation. Namely, any one of the Group 1 NFs can decide or control to inform or notify at least one or some of its related Group 2 NFs accordingly. Therefore, similar to proactive information or notification, avoiding or minimizing service interruption during energy saving procedures in the SB-(R)AN can be supported or even enhanced.

Further, the information or notification (e.g. the indication of deactivation or energy saving) from the Group 1 NFs to (at least one or some of) the Group 2/3 NFs can include an inactivity period, i.e. an indication of a time period in which the Group 1 NFs will be deactivated or put in an energy saving mode according to the energy saving request/command. Hence, when energy saving can be performed temporarily at a specified granularity, the time period of inactivity can be indicated to the Group 1 NFs (from the CU) and then, from the Group 1 NFs, to (at least one or some of) the Group 2/3 NFs. Namely, any one of the Group 1 NFs can decide or control to inform or notify at least one or some of its related Group 2/3 NFs accordingly. This enables the (the thus informed or notified at least one or some of the) Group 2 NFs to optionally keep existing or pending connections alive, avoiding connection re-establishment latencies, and/or this enables the (the thus informed or notified at least one or some of the) Group 3 NFs to have proper/current connection information, i.e. about valid or invalid connections. Accordingly, there may be a (temporary) inactivity period signaling to involved entities or components in the SB-(R)AN.

In view thereof, it is to be noted that Group 1 NFs are service producer entities to Group 2/3 NFs but they may also be service consumer entities of other NFs. In this case, e.g. when an inactivity period is provided, Group 1 NFs can decide to make the connection inactive with the NFs from which they consume services. Generally, in a SB-(R)AN, any authorized NF can consume services of any other service producing NF/NFs.

Finally, the Group 1 NFs enter the inactivity state, i.e. they initiate the requested/commanded energy saving mode. In the present example, all entities or components having dot-and-dash-line boxes in FIG. 3 are made inactive, shut down, deactivated, or the like, such that energy saving is effectuated or shut down at the specified granularity.

For the sake of completeness, it is to be noted that the thus illustrated deactivation of a cell may encompass deactivation of at least one sector and/or at least one beam thereof/therein. Similarly, the thus illustrated deactivation of a NF may encompass deactivation of a part thereof, such as a microservice thereof/therein, and the like.

It is to be noted that the closing of connections, i.e. affected connections, which are concerned by the requested/commanded energy saving mode, may refer to UE(-related) connections and/or service(-related) connections, respectively. For UE(-related) connections, closing may imply changing the state of the associated UE(s), e.g. bringing it/them to an idle or inactive state/mode. For service(-related) connections, closing may imply (logically or functionally) disconnecting associated NFS, e.g. a pair of a NF representing a service producer entity (i.e. a Group 1 NF) and a NF representing a service consumer entity (i.e. a Group 2 NF), which could be performed/effected at one or both of these NFs.

Also, it may be regarded as closing of an entity when the entity enters an energy saving mode. That is, the closing of an entity may imply initiating an energy saving mode, i.e. when any service producer entity (i.e. one or more of Group 1 NFs) that is concerned by the requested/commanded energy saving mode applies the energy saving as requested/commanded by the energy saving request/command. This may include, e.g., physical shut down, entering an inactive or deactivated state, or the like (i.e. any kind of physical and/or functional and/or logical energy saving) at/by/of the entity.

FIG. 4 shows a sequence diagram illustrating an example of an energy saving procedure (or energy saving service procedure) according to at least one exemplifying embodiment, namely a message sequence chart for energy saving in a SB-(R)AN. Namely, the thus illustrated energy saving procedure may be realized by/in an energy saving service according to at least one exemplifying embodiment.

In the sequence diagram of FIG. 4, the involved entities or components, i.e. the CU, etc., can be the same or corresponding to the example of FIG. 3 (thus referring to the description of FIG. 3 for further details and/or characteristics), but are not limited thereto. Rather, the CU stands for any entity or component configured to capture an energy saving entity or component configured to command/request and/or to control or support the Group 1/2/3 NFs. For example, the CU may also represent or be replaced by a CU-CP.

In step 1, an energy saving command/request is received at a high granularity by/at the CU. As indicated above, the energy saving command/request may be received in a central or distributed way, e.g. by/from a central entity or any distributed entity. The energy saving command/request defines or at least allows deducing the Group 1 NFs to be deactivated (i.e. put in an energy saving state), namely the specified granularity for/of energy saving. To this end, the energy saving request/command can include corresponding information, such as e.g. identifiers of/for the Group 1 NFs, or any other information that helps or enables deducing the Group 1 NFs. The energy saving command/request can optionally also include an inactivity period (for any one of the Group 1 NFs) and/or alternative NFs (for any one of the Group 1 NFs).

In step 2a, the Group 1 NFs are informed, i.e. requested or commanded, accordingly. To this end, the CU may identify and/or retrieve information of the Group 1 NFs, i.e. the one of more NFs to notify or request/command, e.g. based on the energy saving request/command. Such information or notification may be accomplished either via broadcast or one-to-one communication. For example, the energy saving command/request received by/at the CU may be forwarded to the affected Group 1 NFs, or some other/modified energy saving command/request may be transmitted to the affected Group 1 NFs. Namely, an energy saving command/request at a high granularity may be provided to the Group 1 NFs to be deactivated. Like in step 1, the energy saving command/request can optionally also include an inactivity period (for any one of the Group 1 NFs) and/or alternative NFs (for any one of the Group 1 NFs). This energy saving command/request can subsequently be confirmed/acknowledged by the Group 1 NFs, as indicated by step 2b, where applicable.

In step 3a, the Group 1 NFs proactively inform the Group 2 NFs and the Group 3 NFs (where appropriate), i.e. notify the Group 2/3 NFs of their requested/commanded deactivation. To this end, any Group 1 NF may identify and/or retrieve information of the one or more Group 2/3 NFs, i.e. the one or more Group 2 and/or Group 3 NFs to notify or inform, namely the Group 2/3NFs which are or were consuming at least one service of/by the respective Group 1 NF. Such information or notification may be accomplished either via broadcast or one-to-one communication. For example, an energy saving indication, which may optionally include an inactivity period and/or alternative NFs, may be provided from the Group 1 NFs to their respective Group 2/3 NFS, respectively. This energy saving indication can subsequently be confirmed/acknowledged by the Group 2/3 NFs, as indicated by step 3b, where applicable.

As noted above, data of the Group 2/3 NFs can be stored in, updated at and/or retrieved from a node or entity that has storage capabilities of Group 3 NFs and/or Group 2 NFs information, such as a network repository function and/or a data storage function of the SB-(R)RAN ((R)AN-DSF) so as to be identifiable/detectable by the Group 1 NFs. The thus stored Group 2/3 NFs information can be subject to one or more mechanisms/methods that determine their storage state, such as a timer expiry.

More generally, any configuration of a base station entity, unit or component realizing energy saving operations or procedures according to at least one exemplifying embodiment is applicable. For example, any configuration of gNB or ng-eNB or en-gNB in a SB-(R)AN is applicable.

In step 4a, associated UEs' contexts can be synchronized. Namely, UE contexts of associated UEs, which are concerned by the requested/commanded energy saving mode, can be synchronized e.g. by/at the UMF of the CU. In step 4b, NF registries can be updated. Namely, registers of the NFs, i.e. any one of the Group 1 and/or Group 2 and/or Group 3 NFs, can be updated by/at a corresponding entity or component, such as e.g. the (R)AN-NRF.

In step 5, existing subscriptions can be removed or cleared, and/or existing or pending connections can be closed (if needed). Namely, existing subscriptions, which are concerned by the requested/commanded energy saving mode, can be removed or cleared, and/or affected connections, which are concerned by the requested/commanded energy saving mode, can be closed at respective Group 2/3 NFs based on (the information of/in) the energy saving indication from the related Group 1 NFs, respectively.

Although not specifically illustrated in FIG. 4, the Group 2/3 NFs can control their operations based on the energy saving indication from their corresponding Group 1 NFs, respectively. For example, when a Group 2 NF receives an indication of an inactivity period of a temporary deactivation of a Group 1 NF, from or via which it currently consumes a service, the Group 2 NF can decide as to whether or not an existing or pending connection is to be closed in view of the length of the announced inactivity period, and/or can decide as to whether or not the currently consumed service is to be transferred or taken over by an alternative NF (potentially in view of the length of the announced inactivity period), if alternative NFs are indicated or known.

In step 6, the Group 1 NFs enter an inactive state, i.e. they initiate the energy saving mode according to the energy saving request from the CU. As noted above, it may be said that the Group 1 NFs are thus closed, physically and/or functionally and/or logically.

As one example, referring to FIGS. 3 and/or 4, the Group 1 NFs could be/comprise a network function providing a service regarding dual connectivity (i.e. a service allowing an UE to communicate via different communication techniques, standards or means, such as e.g. multiple gNBs). If so, the Group 2 NFs could be/comprise internal NF/NFs of the Group 1 NFs and/or at least one other gNB (which has or provides for a dual connectivity service operation with the Group 1 NFs), and the Group 3 NFs could be/comprise internal NF/NFs of the Group 1 NFs and/or at least one other gNB (which had or provided for a dual connectivity service operation with the Group 1 NFs). In such case, in/by a corresponding energy saving indication, the Group 1 NFs could let the Group 2/3 NFs know that the respective internal NF/NFs and/or at least one other gNB that it will not be supported.

As evident from the foregoing description, especially referring to FIGS. 3 and 4, energy saving, including energy saving optimization, can be effected with high/increased granularity, e.g. on any one of a DU level and/or a ell level and/or a sector level and/or a beam level and/or a NF level and/or a microservice level, or the like. Such finely granular energy saving in a (radio) access network can be achieved by employing a service-based architecture (SBA) including service-based interfaces (SBI) and, consequently, a flexible and independent deployment of network functions.

In the foregoing description, some specific examples in terms of energy saving operations and procedures according to the present disclosure are explained. However, it is understood that these examples are illustrative and not restrictive in all respects, and the present disclosure is not limited accordingly. Rather, the present disclosure is more broadly applicable, as is outlined in the following description which provides for at least some exemplifying embodiments in more general terms.

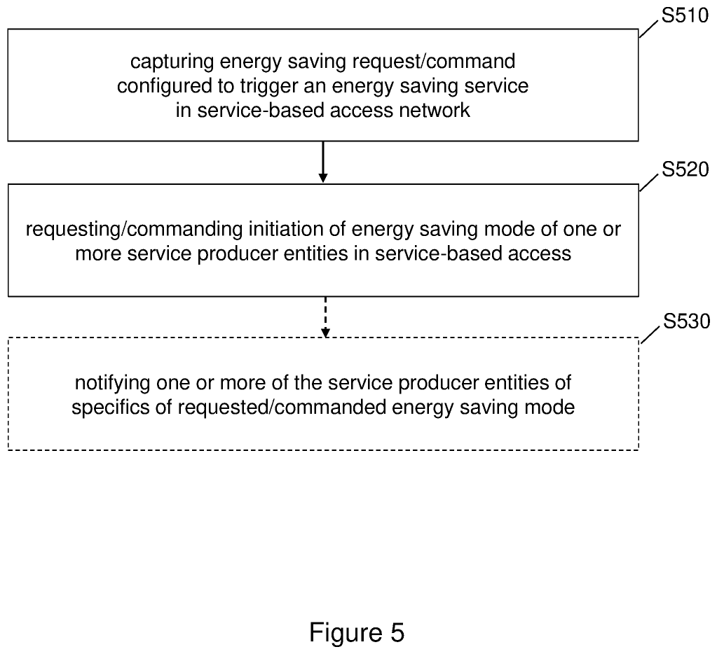

FIG. 5 shows a flowchart illustrating an example of a method or process according to at least one exemplifying embodiment. The method or process of FIG. 5 is a method or process of (or, stated in other words, operable or for use in/by) a node or element in a service-based access network, such as e.g. the CU in FIG. 3 or FIG. 4.

As shown in FIG. 5, the method or process comprises an operation (S510) of capturing an energy saving request or command which is configured to trigger an energy saving service in the service-based access network, and an operation (S520) of requesting or commanding initiation of an energy saving mode of one or more service producer entities in the service-based access network according to the energy saving request or command.

For example, referring to FIG. 3, the CU receives an energy saving request or command from an O-RAN RIC, SMO, OAM, etc. entity. Based on its contents, e.g. identifiers of one or more NFs to be deactivated, the CU requests or commands the thus deduced or identified NFs, e.g. by forwarding or sending a corresponding energy saving request or command.

It is to be noted that the energy saving request or command may be captured by receiving a corresponding request/command, e.g. in the form of a message or signaling, from another node, element or entity of the service-based access network or another network such as a core network, or by locally identifying, determining, detecting, etc. a corresponding request/command, e.g. by internal controls, policies, or the like.

As shown in FIG. 5 (by a dashed-line box), the method or process may additionally comprise an operation (S530) of notifying one or more of the service producer entities of specifics of the requested or commanded energy saving mode (and/or identifying and/or retrieving information of the one or more service producer entities). As described above, such specifics may exemplarily comprise an inactivity period specifying a time period of inactivity in the energy saving mode of a respective service producer entity, and/or a service producer alternative specifying one or more alternative (authorized) service producer entities which are configured to produce a similar or equivalent service as a respective service producer entity.

In or by way of the method of FIG. 5, it may be achieved that UE contexts of associated user equipment entities, which are concerned by the requested or commanded energy saving mode, are synchronized in or for the one or more service producer entities, and/or registers of the one or more service producer entities are updated, and/or existing subscriptions, which are concerned by the requested or commanded energy saving mode, are removed or cleared, and/or affected connections, which are concerned by the requested or commanded energy saving mode, are closed.

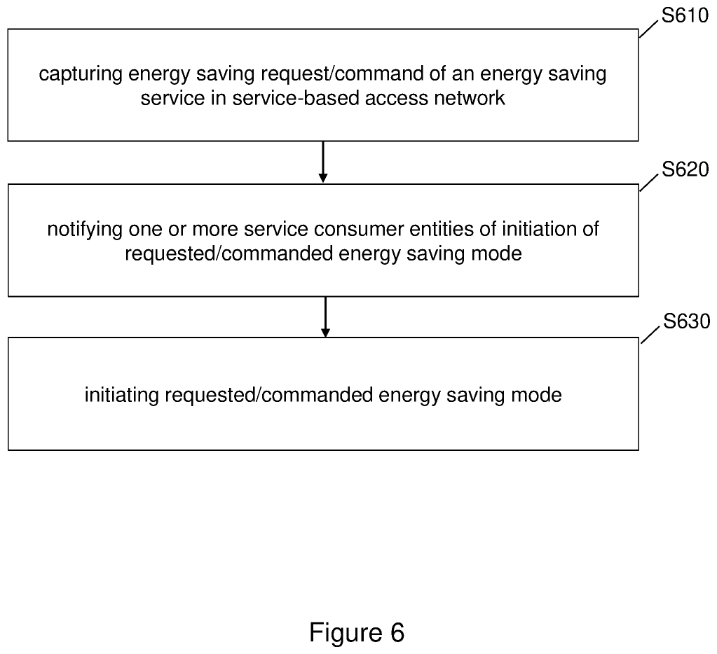

FIG. 6 shows a flowchart illustrating an example of a method or process according to at least one exemplifying embodiment. The method or process of FIG. 6 is a method or process of (or, stated in other words, operable or for use in/by) a node or element in a service-based access network, such as e.g. any one of the entities or components to be deactivated, like the indicated NF in the left DU, the middle DU and the left cell being served/controlled by the right DU, in FIG. 3 or any one of the Group 1 NFs in FIG. 4.

As shown in FIG. 6, the method or process comprises an operation (S610) of capturing an energy saving request or command of an energy saving service in the service-based access network, which is configured to request or command initiation of an energy saving mode, an operation (S620) of notifying one or more service consumer entities of initiation of the requested or commanded energy saving mode, and an operation (S630) of initiating the requested or commanded energy saving mode. As mentioned above, the notifying operation may comprise identifying and/or retrieving information of the one or more service consumer entities, and/or notifying the one or more service consumer entities of specifics of the requested or commanded energy saving mode.

For example, referring to FIG. 3, the indicated NF in the left DU receives an energy saving request or command from the CU. Then, potentially taking into account the contents of the request/command and/or internal data, control or policies, it notifies one or more NFs representing service consumer entities of its service(s) of the requested/commanded deactivation, followed by its deactivation, i.e. initiation of the requested/commanded energy saving mode.

It is to be noted that the energy saving request or command may be captured by receiving a corresponding request/command, e.g. in the form of a message or signaling, from another node, element or entity of the service-based access network or another network such as a core network, or by locally identifying, determining, detecting, etc. a corresponding request/command, e.g. by internal controls, policies, or the like.

As described above, in the notifying, the one or more service consumer entities may be notified of specifics of the requested or commanded energy saving mode. Such specifics may exemplarily comprise an inactivity period specifying a time period of inactivity in the energy saving mode of the node or element, and/or a service producer alternative specifying one or more alternative (authorized) service producer entities which are configured to produce a similar or equivalent service as the node or element.

In or by way of the method of FIG. 6, it may be achieved that registers of the one or more service producer entities are updated, and/or existing subscriptions, which are concerned by the requested or commanded energy saving mode, are removed or cleared, and/or affected connections, which are concerned by the requested or commanded energy saving mode, are closed.

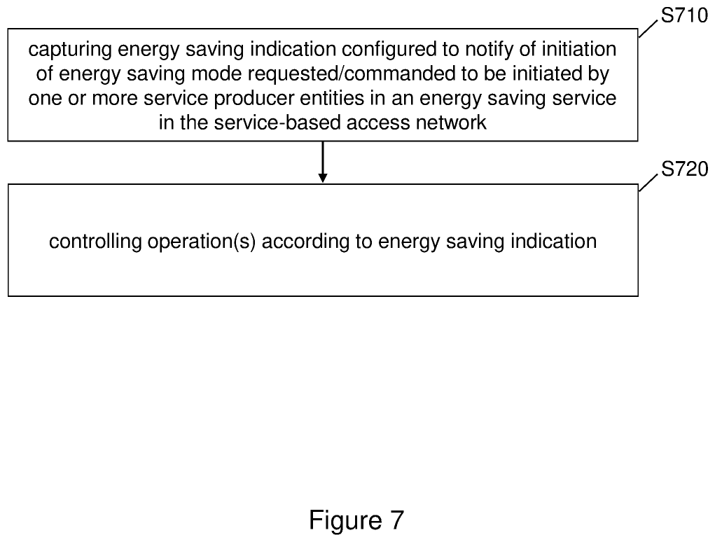

FIG. 7 shows a flowchart illustrating an example of a method or process according to at least one exemplifying embodiment. The method or process of FIG. 7 is a method or process of (or, stated in other words, operable or for use in/by) a node or element in a service-based access network, such as e.g. any service consumer entity relating to the entities or components to be deactivated in FIG. 3 or any one of the Group 2 NFs and/or the Group 3 NFs in FIG. 4.

As shown in FIG. 7, the method or process comprises an operation (S710) of capturing an energy saving indication which is configured to notify of initiation of an energy saving mode which is requested or commanded to be initiated by one or more service producer entities in an energy saving service in the service-based access network, and an operation (S720) of controlling operation (i.e. one or more operations, processed, or the like) according to the energy saving indication.

For example, referring to FIG. 3, a NF representing a service consumer entity of at least one service of at least one service producer entity requested/commanded to be deactivated captures an energy saving indication from the at least one service producer entity, and controls its operation(s) accordingly.

The energy saving indication may be configured to notify of and/or comprise specifics of the energy saving mode which is requested or commanded to be initiated by the one or more service producer entities. As described above, the specifics may exemplarily comprise an inactivity period specifying a time period of inactivity in the energy saving mode of the one or more service producer entities, and/or a service producer alternative specifying one or more alternative (authorized) service producer entities which are configured to produce a similar or equivalent service as the one or more service producer entities.

In the method of FIG. 7, the controlling may be such that (it may be achieved that) registers of the one or more service producer entities are updated, and/or existing subscriptions, which are concerned by the requested or commanded energy saving mode, are removed or cleared, and/or affected connections, which are concerned by the requested or commanded energy saving mode, are closed. Further, the controlling may be such that (it may be achieved that) affected connections, which are concerned by the requested or commanded energy saving mode, are converted to inactive or idle mode/state and such converted (inactive/idle) connections are kept/maintained (e.g. by using small transmission, such as a heartbeat signal), and/or new connections are established with one or more (authorized) service producer alternatives as identified in the specifics.

By virtue of exemplifying embodiments of the present disclosure, as evident from the above, energy saving in a service-based (radio) access network, i.e. a service-based (R)AN environment, can be enabled/realized. Moreover, energy saving in the service-based (radio) access network can be enabled/realized at a specified granularity, e.g. a higher granularity as feasible for energy saving in modern mobile/wireless communication systems.

As evident from the above, exemplifying embodiments of the present disclosure provide for a technique to perform energy saving, i.e. provide an energy saving service, in consideration of or based on SBA principles. To this end, SB-(R)AN architecture (or framework) and service-based interfaces (SBIs) are utilized. More specifically, energy saving optimizations can be achieved in a SB-(R)AN by way of one or more of the above-described operations, procedures, methods or processes, i.e. the thus introduced energy saving functionality and its related operations, procedures, methods or processes, which provide for finer granularity.

Accordingly, exemplifying embodiments of the present disclosure teach the application of SBA principles to the (R)AN and the associated interfaces, together with corresponding updates, such as the adaptation of existing mechanisms and functions to such concept as well as the definition of new functions and services that are beneficial or crucial for operating under this concept, so as to enable energy saving (at a specified granularity) in the SB-(R)AN.

With exemplifying embodiments of the present disclosure, one or more of the following effects or benefits can thus be achieved:
specified, e.g. higher, granularity for energy saving (as a SB-(R)AN service) on various levels,
consideration of mutual dependencies between NFs for avoidance of service interruption due to energy saving,
temporary deactivation for latency reduction in connection re-establishment,
proactive information exchange between the concerned entities or components for reduced/zero service interruption and valid/invalid connections update,
provision of alternative (authorized) NFs for service continuation.

Benefits in terms of energy saving can thus be achieved in a mobile/wireless communication system having a service-based (radio) access network. More specifically, the handling or processing of energy saving in the case of produced/consumed services in a SB-(R)AN can be achieved.

The above-described functionality as well as its related operations, procedures, methods and processes may be implemented by respective functional elements, entities, modules, units, processors, or the like, as described below. These functional elements, entities, modules, units, processors, or the like, i.e. the implementation of one or more exemplifying embodiments, may be realized in a cloud environment.

While in the foregoing exemplifying embodiments of the present disclosure are described mainly with reference to operations, procedures, methods and processes, corresponding exemplifying embodiments of the present disclosure also cover respective apparatuses, entities, modules, units, network nodes and/or systems, including software and/or hardware thereof.

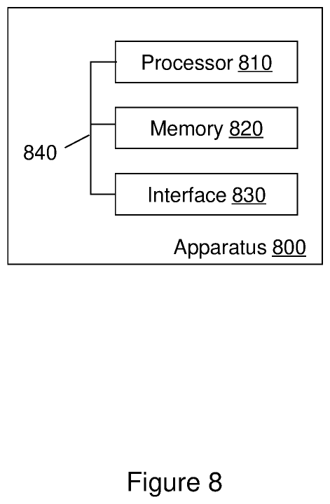

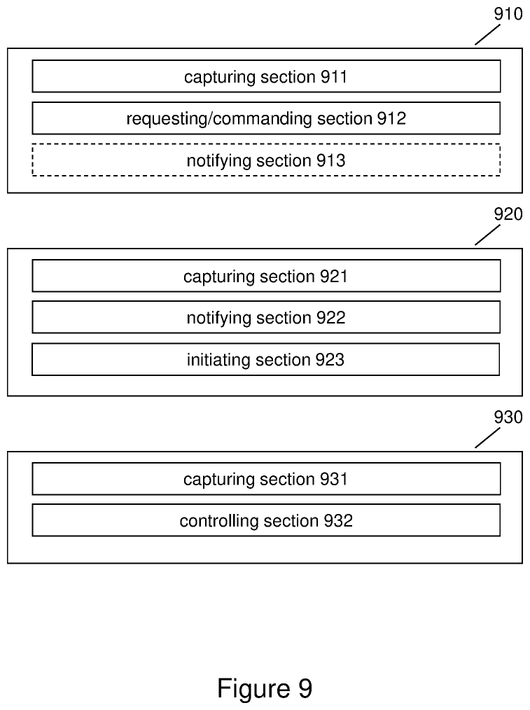

Respective exemplifying embodiments of the present invention are described below referring to FIGS. 8 and 9, while for the sake of brevity reference is made to the detailed description of respective corresponding configurations/setups, schemes, processes, sequences, methods as well as functionalities, principles and operations according to FIGS. 2 to 7.

In FIGS. 8 and 9, the blocks are basically configured to perform respective methods, procedures and/or functions as described above. The entirety of blocks are basically configured to perform the methods, procedures and/or functions as described above, respectively. With respect to FIGS. 8 and 9, it is to be noted that the individual blocks are meant to illustrate respective functional blocks implementing a respective function, process or procedure, respectively. Such functional blocks are implementation-independent, i.e. may be implemented by means of any kind of hardware or software or combination thereof, respectively.

Further, in FIGS. 8 and 9, only those functional blocks are illustrated, which relate to any one of the above-described methods, procedures and/or functions. A skilled person will acknowledge the presence of any other conventional functional blocks required for an operation of respective structural arrangements, such as e.g. a power supply, a central processing unit, respective memories or the like. Among others, one or more memories are provided for storing programs or program instructions for controlling or enabling the individual functional entities or any combination thereof to operate as described herein in relation to exemplifying embodiments.

FIG. 8 shows a schematic diagram illustrating an example of a structure of apparatuses according to at least one exemplifying embodiment. Herein, an apparatus can represent a physical entity or component, i.e. a structural device implementing a specific network element, entity or function or the functionality thereof as such, or a functional or logical entity or component. For example, the thus illustrated apparatus may be realized in or by a server or the like in a cloud environment, i.e. by a cloud-based implementation.

As indicated in FIG. 8, according to at least one exemplifying embodiment, an apparatus 800 may comprise or realize at least one processor 810 and at least one memory 820 (and possibly also at least one interface 830), which may be operationally connected or coupled, for example by a bus 840 or the like, respectively.

The processor 810 and/or the interface 830 of the apparatus 800 may also include a modem or the like to facilitate communication over a (hardwire or wireless) link, respectively. The interface 830 of the apparatus 800 may include a suitable transmitter, receiver or transceiver connected or coupled to one or more antennas, antenna units, such as antenna arrays or communication facilities or means for (hardwire or wireless) communications with the linked, coupled or connected device(s), respectively. The interface 830 of the apparatus 800 is generally configured to communicate with at least one other apparatus, device, node or entity (in particular, the interface thereof).

The memory 820 of the apparatus 800 may represent a (non-transitory/tangible) storage medium (e.g. RAM, ROM, EPROM, EEPROM, etc.) and store respective software, programs, program products, macros or applets, etc. or parts of them, which may be assumed to comprise program instructions or computer program code that, when executed by the respective processor, enables the respective electronic device or apparatus to operate in accordance with the exemplifying embodiments of the present invention. Further, the memory 820 of the apparatus 800 may (comprise a database to) store any data, information, or the like, which is used in the operation of the apparatus.

In general terms, respective apparatuses (and/or parts thereof) may represent means for performing respective operations and/or exhibiting respective functionalities, and/or the respective devices (and/or parts thereof) may have functions for performing respective operations and/or exhibiting respective functionalities.

In view of the above, the thus illustrated apparatus 800 is suitable for use in practicing one or more of the exemplifying embodiments, as described herein.

When in the subsequent description it is stated that the processor (or some other means) is configured to perform some function, this is to be construed to be equivalent to a description stating that a (i.e. at least one) processor or corresponding circuitry, potentially in cooperation with a computer program code stored in the memory of the respective apparatus or otherwise available (it should be appreciated that the memory may also be an external memory or provided/realized by a cloud service or the like), is configured to cause the apparatus to perform at least the thus mentioned function. It should be appreciated that herein processors, or more generally processing portions, should not be only considered to represent physical portions of one or more processors, but may also be considered as a logical division of the referred processing tasks performed by one or more processors.

According to at least one exemplifying embodiment, the thus illustrated apparatus 800 may represent or realize/embody a (part of a) node or element in a SB-(R)AN. More specifically, the apparatus 800 may be configured to perform a procedure and/or exhibit a functionality and/or implement a mechanism, as described (for a CU) in any one of FIGS. 3, 4 and 5.

Accordingly, the apparatus 800 may be caused or the apparatus 800 or its at least one processor 810 (possibly together with computer program code stored in its at least one memory 820), in its most basic form, is configured to capture an energy saving request or command which is configured to trigger an energy saving service in the service-based access network, and to request or command initiation of an energy saving mode of one or more service producer entities in the service-based access network according to the energy saving request or command. Such apparatus 800 may also be configured to notify one or more of the service producer entities of specifics of the requested or commanded energy saving mode.

According to at least one exemplifying embodiment, the thus illustrated apparatus 800 may represent or realize/embody a (part of a) node or element in a SB-(R)AN. More specifically, the apparatus 800 may be configured to perform a procedure and/or exhibit a functionality and/or implement a mechanism, as described (for Group 1 NFs) in any one of FIGS. 3, 4 and 6.

Accordingly, the apparatus 800 may be caused or the apparatus 800 or its at least one processor 810 (possibly together with computer program code stored in its at least one memory 820), in its most basic form, is configured to capture an energy saving request or command of an energy saving service in the service-based access network, which is configured to request or command initiation of an energy saving mode, to notify one or more service consumer entities of initiation of the requested or commanded energy saving mode, and to initiate the requested or commanded energy saving mode.

According to at least one exemplifying embodiment, the thus illustrated apparatus 800 may represent or realize/embody a (part of a) node or element in a SB-(R)AN. More specifically, the apparatus 800 may be configured to perform a procedure and/or exhibit a functionality and/or implement a mechanism, as described (for Group 2/3 NFs) in any one of FIGS. 3, 4 and 7.

Accordingly, the apparatus 800 may be caused or the apparatus 800 or its at least one processor 810 (possibly together with computer program code stored in its at least one memory 820), in its most basic form, is configured to capture an energy saving indication which is configured to notify of initiation of an energy saving mode which is requested or commanded to be initiated by one or more service producer entities in an energy saving service in the service-based access network, and to control operation according to the energy saving indication.

As mentioned above, an apparatus according to at least one exemplifying embodiment may be structured by comprising respective units or means for performing corresponding operations, procedures and/or functions. For example, such units or means may be implemented/realized on the basis of an apparatus structure, as exemplified in FIG. 8, i.e. by one or more processors 610, one or more memories 820, one or more interfaces 830, or any combination thereof.

FIG. 9 shows a schematic diagram illustrating an example of a structure of apparatuses according to at least one exemplifying embodiment. For example, any one of the thus illustrated apparatuses may be realized in or by a server or the like in a cloud environment, i.e. by a cloud-based implementation.

As shown in FIG. 9, an apparatus 910 according to at least one exemplifying embodiment may represent or realize/embody a (part of a) node or element in a SB-(R)AN. Hence, the apparatus 910 may be configured to perform a procedure and/or exhibit a functionality and/or implement a mechanism, as described (for a CU) in any one of FIGS. 3, 4 and 5.

Such apparatus may comprise (at least) a capturing unit/means/circuitry denoted by capturing section 911, which represents any implementation for (or configured to) capturing (capture) an energy saving request or command which is configured to trigger an energy saving service in the service-based access network, and a requesting/commanding unit/means/circuitry denoted by requesting/commanding section 912, which represents any implementation for (or configured to) requesting or commanding (request or command) initiation of an energy saving mode of one or more service producer entities in the service-based access network according to the energy saving request or command. Also, as indicated by a dashed-line box, such apparatus may comprise a notifying unit/means/circuitry denoted by capturing section 913, which represents any implementation for (or configured to) notifying (notify) one or more of the service producer entities of specifics of the requested or commanded energy saving mode. As described above, the notifying unit/means/circuitry 913 may also be for (or configured to) identifying and/or retrieving (identify and/or retrieve) information of the one or more service producer entities.

As shown in FIG. 9, an apparatus 920 according to at least one exemplifying embodiment may represent or realize/embody a (part of a) node or element in a SB-(R)AN. Hence, the apparatus 920 may be configured to perform a procedure and/or exhibit a functionality and/or implement a mechanism, as described (for Group 1 NFs) in any one of FIGS. 3, 4 and 6.

Such apparatus may comprise (at least) a capturing unit/means/circuitry denoted by capturing section 921, which represents any implementation for (or configured to) capturing (capture) an energy saving request or command of an energy saving service in the service-based access network, which is configured to request or command initiation of an energy saving mode, a notifying unit/means/circuitry denoted by notifying section 922, which represents any implementation for (or configured to) notifying (notify) one or more service consumer entities of initiation of the requested or commanded energy saving mode, and an initiating unit/means/circuitry denoted by initiating section 923, which represents any implementation for (or configured to) initiating (initiate) the requested or commanded energy saving mode. As described above, the notifying unit/means/circuitry 922 may, amongst others, be for (or configured to) identifying and/or retrieving (identify and/or retrieve) information of the one or more service consumer entities, and/or notifying (notify) the one or more service consumer entities of specifics of the requested or commanded energy saving mode.

As shown in FIG. 9, an apparatus 930 according to at least one exemplifying embodiment may represent or realize/embody a (part of a) node or element in a SB-(R)AN. Hence, the apparatus 930 may be configured to perform a procedure and/or exhibit a functionality and/or implement a mechanism, as described (for Group 2/3 NFs) in any one of FIGS. 3, 4 and 7.

Such apparatus may comprise (at least) a capturing unit/means/circuitry denoted by capturing section 931, which represents any implementation for (or configured to) capturing (capture) an energy saving indication which is configured to notify of initiation of an energy saving mode which is requested or commanded to be initiated by one or more service producer entities in an energy saving service in the service-based access network, and a controlling unit/means/circuitry denoted by controlling section 932, which represents any implementation for (or configured to) controlling (control) operation according to the energy saving indication.

For further details regarding the operability/functionality of the apparatuses (or units/means thereof) according to exemplifying embodiments, reference is made to the above description in connection with any one of FIGS. 2 to 7, respectively.

With regard to FIGS. 8 and 9, it is to be noted that the thus illustrated structures of apparatuses are merely examples, and the blocks therein, including their respective functions, can be different and/or combined, as appropriate, for the overall implementation/realization of exemplary embodiments of the present disclosure.

According to exemplifying embodiments of the present disclosure, any one of the (at least one) processor, the (at least one) memory and the (at least one) interface, as well as any one of the illustrated units/means, may be implemented as individual modules, chips, chipsets, circuitries or the like, or one or more of them can be implemented as a common module, chip, chipset, circuitry or the like, respectively.

According to exemplifying embodiments of the present disclosure, a system may comprise any conceivable combination of any depicted or described apparatuses and other network elements or functional entities, which are configured to cooperate as described above.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, a basic system architecture of a (tele)communication network including a mobile communication system where some examples of exemplifying embodiments are applicable may include an architecture of one or more communication networks including wireless access network sub-/system(s) and possibly core network(s). Such an architecture may include one or more communication network control elements or functions, such as e.g. access network elements, radio access network elements, access service network gateways or base transceiver stations, like a base station, an access point, a NodeB (NB), an eNB or a gNB, a distributed or a centralized unit, which controls a respective coverage area or cell(s) and with which one or more communication stations such as communication elements or functions, like user devices or terminal devices, like a UE, or another device having a similar function, such as a modem chipset, a chip, a module etc., which can also be part of a station, an element, a function or an application capable of conducting a communication, such as a UE, an element or function usable in a machine-to-machine communication architecture, or attached as a separate element to such an element, function or application capable of conducting a communication, or the like, are capable to communicate via one or more channels via one or more communication beams for transmitting several types of data in a plurality of access domains. Furthermore, core network elements or network functions, such as gateway network elements/functions, mobility management entities, a mobile switching center, servers, databases and the like may be included.

The general functions and interconnections of the described elements and functions, which also depend on the actual network type, are known to those skilled in the art and described in corresponding specifications, so that a detailed description thereof is omitted herein. It should be appreciated that several additional network elements and signaling links may be employed for a communication to or from an element, function or application, like a communication endpoint, a communication network control element, such as a server, a gateway, a radio network controller, and other elements of the same or other communication networks besides those described in detail herein below.

A communication network architecture as being considered in examples of exemplifying embodiments may also be able to communicate with other networks, such as a public switched telephone network or the Internet, including the Internet-of-Things. The communication network may also be able to support the usage of cloud services for virtual network elements or functions thereof, wherein it is to be noted that the virtual network part of the (tele)communication network can also be provided by non-cloud resources, e.g. an internal network or the like. It should be appreciated that network elements of an access system, of a core network etc., and/or respective functionalities may be implemented by using any node, host, server, access node or entity etc. being suitable for such a usage. Generally, a network function can be implemented either as a network element on a dedicated hardware, as a software instance running on a dedicated hardware, or as a virtualized function instantiated on an appropriate platform, e.g. a cloud infrastructure.

Any method step is suitable to be implemented as software or by hardware without changing the idea of the present disclosure. Such software may be software code independent and can be specified using any known or future developed programming language, such as e.g. Java, C++, C, and Assembler, as long as the functionality defined by the method steps is preserved. Such hardware may be hardware type independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components. A device/apparatus may be represented by a semiconductor chip, a chipset, or a (hardware) module comprising such chip or chipset; this, however, does not exclude the possibility that a functionality of a device/apparatus or module, instead of being hardware implemented, be implemented as software in a (software) module such as a computer program or a computer program product comprising executable software code portions for execution/being run on a processor. A device may be regarded as a device/apparatus or as an assembly of more than one device/apparatus, whether functionally in cooperation with each other or functionally independently of each other but in a same device housing, for example.

Apparatuses and/or units/means or parts thereof can be implemented as individual devices, but this does not exclude that they may be implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present disclosure also covers any conceivable combination of method steps and operations described above, and any conceivable combination of nodes, apparatuses, modules or elements described above, as long as the above-described concepts of methodology and structural arrangement are applicable.

In view of the above, there are provided measures for enabling/realizing energy saving in a service-based access network such as a service-based radio access network, particularly energy saving at a specified granularity in a service-based access network such as a service-based radio access network. Such measures exemplarily comprise that a node or element in the service-based access network captures an energy saving request or command of an energy saving service in the service-based access network, wherein the energy saving request or command enables that the specified granularity can be deduced, and is configured to request or command initiation of an energy saving mode, notifies one or more service consumer entities of initiation of the requested or commanded energy saving mode, and initiates the requested or commanded energy saving mode.

Even though the present disclosure is described above with reference to the examples according to the accompanying drawings, it is to be understood that the present disclosure is not restricted thereto. Rather, it is apparent to those skilled in the art that the present disclosure can be modified in many ways without departing from the scope of the inventive idea as disclosed herein.

### LIST OF ACRONYMS AND ABBREVIATIONS

3GPP 3rd Generation Partnership Project
5G 5^{th} Generation
5GC 5G Core (network)
5GS 5G System
6G 6^{th} Generation
7G 7^{th} Generation
AF Application Function
AMF Access and Mobility Management Function
API Application Program Interface
AUSF Authentication Server Function
CMF Cell Management Function
CN Core Network
CU Central Unit
CU CP Central Unit Control Plane
CU UP Central Unit User Plane
DAF Data Analytics Function
DN Data Network
DSF Data Storage Function
DU Distributed Unit
HTTP HypterText Transfer Protocol
HTTPS HTTP Secure
NEF Network Exposure Function
NF Network Function
NG Network Generation
NG-C NG Control Plane Interface
NR New Radio
NRF Network Repository Function
NSSF Network Slice Selection Function
OAM Operations, Administration and Maintenance
O-RAN RIC Open-RAN Intelligent Controller
P2P Point-to-Point
PCF Policy Control Function
(R)AN (Radio) Access Network
(R)AN-NRF (R)AN Network Repository Function
RU Remote Unit
SB Service-based
SBA Service-based Architecture
SBI Service-based Interface
SBMA Service-based Management Architecture
SCP Service Communication Proxy
SCTP Stream Control Transmission Protocol
SMF Session Management Function
SMO Service Management and Orchestration
UE User Equipment
UDM Unified Data Management
UMF UE Management Function
UPF User Plane Function

1-27. (canceled)

28. An apparatus of a node or element in a service-based access network,
the apparatus comprising at least one processor and at least one memory including computer program code, wherein the processor, with the at least one memory and the computer program code, is configured to cause the apparatus to perform:
capturing an energy saving request or command which is configured to trigger an energy saving service in the service-based access network, and
requesting or commanding initiation of an energy saving mode of one or more service producer entities in the service-based access network according to the energy saving request or command.

29. The apparatus according to claim 28, wherein the one or more service producer entities comprise at least one of:
one or more network functions, which are configured to produce a service in or for the service-based access network,
one or more microservices, which are configured to produce a service in or for the service-based access network,
one or more communication control entity units, which are configured to produce a service for one or more cells, such as one or more distributed units of a base station entity, and
one or more cells, which are configured to produce a service for one or more user equipment entities, such as a base transceiver or radio entity, and/or one or more sectors of at least one cell and/or one or more beams of at least one cell.

30. The apparatus according to claim 28, wherein the processor, with the at least one memory and the computer program code, is configured to cause the apparatus to perform:
identifying and/or retrieving information of the one or more service producer entities, and/or
notifying one or more of the service producer entities of specifics of the requested or commanded energy saving mode.

31. The apparatus according to claim 28, wherein the processor, with the at least one memory and the computer program code, is configured to cause the apparatus to perform:
identifying and/or retrieving information of the one or more service producer entities, and/or
notifying one or more of the service producer entities of specifics of the requested or commanded energy saving mode, and wherein the specifics comprise at least one of:
an inactivity period specifying a time period of inactivity in the energy saving mode of a respective service producer entity, and
a service producer alternative specifying one or more alternative service producer entities which are configured to produce a similar or equivalent service as a respective service producer entity.

32. The apparatus according to claim 28, wherein the processor, with the at least one memory and the computer program code, is configured to cause the apparatus to perform:
identifying and/or retrieving information of the one or more service producer entities, and/or
notifying one or more of the service producer entities of specifics of the requested or commanded energy saving mode, and wherein
at least one of the requesting or commanding and the notifying is performed by issuing an energy saving request or command to the one or more service producer entities.

33. The apparatus according to any one of claim 28, wherein the processor, with the at least one memory and the computer program code, is configured to cause the apparatus to perform:
synchronizing UE contexts of associated user equipment entities, which are concerned by the requested or commanded energy saving mode, in or for the one or more service producer entities, and/or
updating registers of the one or more service producer entities, and/or
removing or clearing existing subscriptions, which are concerned by the requested or commanded energy saving mode, and/or
closing affected connections, which are concerned by the requested or commanded energy saving mode.

34. The apparatus according to claim 28, wherein the processor, with the at least one memory and the computer program code, is configured to cause the apparatus to perform:
synchronizing UE contexts of associated user equipment entities, which are concerned by the requested or commanded energy saving mode, in or for the one or more service producer entities, and/or
updating registers of the one or more service producer entities, and/or
removing or clearing existing subscriptions, which are concerned by the requested or commanded energy saving mode, and/or
closing affected connections, which are concerned by the requested or commanded energy saving mode, and wherein
the UE contexts are synchronized by issuing a UE context synchronization indication request, and/or
the registers are updated and/or the existing subscriptions are removed or cleared and/or the affected connections are closed at a corresponding network function.

35. The apparatus according to any one of claim 28, wherein capturing the energy saving request or command comprises:
receiving the energy saving request or command in a central way, such as from a central entity, or in a distributed way, such as based on policies or from any service producer entity or network function.

36. The apparatus according to any one of claim 28, wherein
the node or element is or relates to a communication control entity unit, which is configured to produce a control- or management-related service, such as a central unit or a central unit control plane of a base station entity, and/or
the service-based access network is based on a 3GPP standard or part of a 3GPP-based communication system, such as a system of or beyond 5G.

37. An apparatus of a node or element in a service-based access network,
the apparatus comprising at least one processor and at least one memory including computer program code, wherein the processor, with the at least one memory and the computer program code, is configured to cause the apparatus to perform:
capturing an energy saving request or command of an energy saving service in the service-based access network, which is configured to request or command initiation of an energy saving mode,
notifying one or more service consumer entities of initiation of the requested or commanded energy saving mode, and
initiating the requested or commanded energy saving mode.

38. The apparatus according to claim 37, wherein the service consumer entities comprise entities which are consuming a service of or via the node or element and/or entities which were consuming a service of or via the node or element.

39. The apparatus according to claim 37, wherein the service consumer entities comprise at least one of:
one or more network functions,
one or more microservices,
one or more communication control entity units, such as one or more distributed units of a base station entity, and
one or more cells and/or one or more sectors of at least one cell and/or one or more beams of at least one cell.

40. The apparatus according to any one of claim 37, wherein the notifying comprises:
identifying and/or retrieving information of the one or more service consumer entities, and/or
notifying the one or more service consumer entities of specifics of the requested or commanded energy saving mode.

41. The apparatus according to claim 37, wherein the notifying comprises:
identifying and/or retrieving information of the one or more service consumer entities, and/or
notifying the one or more service consumer entities of specifics of the requested or commanded energy saving mode, and wherein the specifics comprise at least one of:
an inactivity period specifying a time period of inactivity in the energy saving mode of the node or element, and
a service producer alternative specifying one or more alternative service producer entities which are configured to produce a similar or equivalent service as the node or element.

42. The apparatus according to claim 37, wherein the notifying comprises:
identifying and/or retrieving information of the one or more service consumer entities, and/or
notifying the one or more service consumer entities of specifics of the requested or commanded energy saving mode, and wherein the specifics comprise at least one of:
an inactivity period specifying a time period of inactivity in the energy saving mode of the node or element, and
a service producer alternative specifying one or more alternative service producer entities which are configured to produce a similar or equivalent service as the node or element, and wherein
the inactivity period is notified to service consumer entities which are consuming a service of or via the node or element and/or service consumer entities which were consuming a service of or via the node or element and/or
the service producer alternative is notified to service consumer entities which are consuming a service of or via the node or element.

43. The apparatus according to any one of claim 37, wherein
the notifying is performed by issuing an energy saving indication to the one or more service consumer entities.

44. The apparatus according to any one of claim 37, wherein the processor, with the at least one memory and the computer program code, is configured to cause the apparatus to perform:
updating registers of the one or more service consumer entities, and/or
removing or clearing existing subscriptions, which are concerned by the requested or commanded energy saving mode, and/or
closing affected connections, which are concerned by the requested or commanded energy saving mode, and/or
converting affected connections, which are concerned by the requested or commanded energy saving mode, to be inactive or idle, and/or
establishing a new connection to at least one alternative service producer entity configured to produce a similar or equivalent service as the node or element.

45. The apparatus according to claim 37, wherein the processor, with the at least one memory and the computer program code, is configured to cause the apparatus to perform:
updating registers of the one or more service consumer entities, and/or
removing or clearing existing subscriptions, which are concerned by the requested or commanded energy saving mode, and/or
closing affected connections, which are concerned by the requested or commanded energy saving mode, and/or
converting affected connections, which are concerned by the requested or commanded energy saving mode, to be inactive or idle, and/or
establishing a new connection to at least one alternative service producer entity configured to produce a similar or equivalent service as the node or element, and wherein
the registers are updated and/or the existing subscriptions are removed or cleared and/or the affected connections are closed at a corresponding network function.

46. The apparatus according to any one of claim 37, wherein capturing the energy saving request or command comprises:
receiving the energy saving request or command from a node or element in the service-based access network, which is or relates to a communication control entity unit, which is configured to produce a control- or management-related service, such as a central unit or a central unit control plane of a base station entity.

47. The apparatus according to any one of claim 37, wherein
the node or element represents a service producer entity which is configured to produce a service in the service-based access network, and/or
the node or element is or relates to one or more of a network function, a microservice, a communication control entity unit, such as a distributed unit of a base station entity, and a cell, and/or
the service-based access network is based on a 3GPP standard or part of a 3GPP-based communication system, such as a system of or beyond 5G.

48. An apparatus of a node or element in a service-based access network,
the apparatus comprising at least one processor and at least one memory including computer program code, wherein the processor, with the at least one memory and the computer program code, is configured to cause the apparatus to perform:
capturing an energy saving indication which is configured to notify of initiation of an energy saving mode which is requested or commanded to be initiated by one or more service producer entities in an energy saving service in the service-based access network, and
controlling operation according to the energy saving indication.

49. The apparatus according to claim 48, wherein the energy saving indication is further configured to notify of specifics of the energy saving mode which is requested or commanded to be initiated by the one or more service producer entities.

50. The apparatus according to claim 48, wherein the energy saving indication is further configured to notify of specifics of the energy saving mode which is requested or commanded to be initiated by the one or more service producer entities, and wherein the specifics comprise at least one of:
an inactivity period specifying a time period of inactivity in the energy saving mode of the one or more service producer entities, and
a service producer alternative specifying one or more alternative service producer entities which are configured to produce a similar or equivalent service as the one or more service producer entities.

51. The apparatus according to any one of claim 48, wherein the controlling comprises:
updating at least one register of the node or element, and/or
removing or clearing existing subscriptions, which are concerned by the requested or commanded energy saving mode, and/or
closing affected connections, which are concerned by the requested or commanded energy saving mode, and/or
converting affected connections, which are concerned by the requested or commanded energy saving mode, to be inactive or idle, and/or
establishing a new connection to at least one alternative service producer entity configured to produce a similar or equivalent service as the one or more service producer entities.

52. The apparatus according to claim 48, wherein the controlling comprises:
updating at least one register of the node or element, and/or
removing or clearing existing subscriptions, which are concerned by the requested or commanded energy saving mode, and/or
closing affected connections, which are concerned by the requested or commanded energy saving mode, and/or
converting affected connections, which are concerned by the requested or commanded energy saving mode, to be inactive or idle, and/or
establishing a new connection to at least one alternative service producer entity configured to produce a similar or equivalent service as the one or more service producer entities, and wherein
the at least one register is updated and/or the existing subscriptions are removed or cleared and/or the affected connections are closed at a corresponding network function.

53. The apparatus according to any one of claim 48, wherein capturing the energy saving indication comprises:
receiving the energy saving indication from a node or element in the service-based access network, which represents a service producer entity which is configured to produce a service in the service-based access network.

54. The apparatus according to any one of claim 48, wherein
the node or element represents a service consumer entity which is configured to consume a service produced by one or more of the service producer entities, and/or
the node or element is or relates to one or more of a network function, a microservice, a communication control entity unit, such as a distributed unit of a base station entity and a cell, and/or
the service-based access network is based on a 3GPP standard or part of a 3GPP-based communication system, such as a system of or beyond 5G.

55. (canceled)
